(19) United States
(12) Patent Application Publication
(10) Pub. No.: US 2015/0151573 A1
(43) Pub. Date: Jun. 4, 2015

(54) SEALING STRUCTURE

(71) Applicant: UCHIYAMA MANUFACTURING CORP., Okayama (JP)

(72) Inventor: Masanori Shibayama, Okayama (JP)

(73) Assignee: UCHIYAMA MANUFACTURING CORP., Okayama (JP)

(21) Appl. No.: 14/399,361

(22) PCT Filed: May 7, 2013
(86) PCT No.: PCT/JP2013/062836

§ 371 Date: Nov. 6, 2014

(30) Foreign Application Priority Data
May 11, 2012 (JP) 2012-109323

(51) Int. Cl. B60B 27/00; F16J 15/32; F16J 15/447

(52) U.S. Cl. CPC B60B 27/0073; F16J 15/447; F16J 15/3232; F16J 15/3268; B60B 2900/5114; B60B 2900/5112; B60B 2900/321

(57) ABSTRACT

A sealing structure includes: an inside member and an outside member. and a sealing member to seal an annular gap S between the inside member and the outside member, the inside member having a flange portion, a non-rusting metallic ring being fitted to the inside member, the sealing member including a lip slidably in contact with the metallic ring. A folded portion is disposed to the metallic ring, the folded portion protruding toward an opposite side of the flange portion in an axial direction, and the outside member includes an extending portion, the extending portion being positioned on an outside in a radial direction with respect to the folded portion of the metallic ring, the extending portion extending toward the flange portion side.

### TECHNICAL FIELD

The present invention relates to a sealing structure of a bearing, in particular, relates to a sealing structure of a bearing using sealing member to be mounted on a flange portion side in a hub bearing that rotatably supports a wheel.

### BACKGROUND ART

A wheel of an automobile or similar vehicle is rotatably supported via, for example, a hub bearing. The hub bearing includes an inner ring, an outer ring, and a rolling element interposed between the and outer rings. The bearing is formed by the outer ring secured to the vehicle body side and a wheel hub as the inner ring, The wheel hub is secured to a rotation (drive rotation or driven rotation) shaft and supported to be rotatable relatively to the outer ring via the rolling element. At one end of the wheel hub, a hub flange that extends in the centrifugal direction is continuously formed. To the hub flange, a tire wheel is secured with bolt. The bearing space where the rolling element is interposed is sealed by a bearing sealing device (seal ring) interposed between the inner and outer rings. This prevents leakage of a lubricant such as grease loaded into the bearing space and prevents invasion of sludge or similar object from outside.

The bearing sealing device on the hub flange side includes: a cored bar press-fitted to the outer-ring inner peripheral portion of the bearing; and a seal lip member formed of an elastic body integrally and fixedly secured to the cored bar. The seal lip member includes a plurality of lips. The seal lip member is constituted such that these lips are elastically brought into contact with the hub flange side of the wheel hub when the seal lip member is press-fitted to the outer-ring inner peripheral portion.

As the bearing sealing device with the above-described configuration, for example, there has been proposed a wheel bearing device with the following structure (see Patent Literatures 1, 2, and 3). In this wheel bearing device, a metallic ring is fitted into the base portion on an inner side of a wheel installation flange. Aside lip of the sealing member integrally joined to the cored bar is slidably in contact with the metallic ring.

This metallic ring includes a circular plate portion and an umbrella portion. The circular plate portion extends outward in the radial direction from a curved portion corresponding to the shape of the base portion On the inner side of the wheel installation flange and is brought into close contact with the side surface on the inner side of the wheel installation flange. The umbrella portion extends from the outer diameter portion of this circular plate portion to be separated from the wheel installation flange in the axial direction.

In the structure of Patent Literature 1, a tapered surface with a predetermined inclined, angle is formed at the outer periphery of an end portion on an outer side of an outer member (outer ring). The umbrella portion of the metallic ring is formed in a taper shape. The taper shape has a predetermined inclined angle and has a diameter gradually expanding toward the end portion. The umbrella portion is placed facing the tapered surface of the outer member through a small annular gap.

In the structure of Patent Literature 2, an umbrella portion of a metallic ring is placed facing an outer member along the outer periphery of an end portion on an outer side of the outer member via small annular gap. In the circumferential direction of the umbrella portion, a plurality of drain holes is disposed to protrude.

In the structure of Patent Literature 3, a bent portion is disposed in an umbrella portion of a metallic ring. The bent portion is formal to protrude outward in the radial direction. The umbrella portion is placed facing an outer member along the outer periphery of an end portion on an outer side of the outer member via a small annular gap. Furthermore, a slinger is press-fitted to the outer periphery of the end portion. This slinger is disposed via a labyrinth seal adjacent to the end portion of the metallic ring.

In Patent Literatures 1, 2, and 3, the respective above-described structures are employed so as to prevent invasion of muddy water or similar object into the metallic ring.

### CITATION LIST

### Patent Literatures

Patent Literature 1: JP-A-2010-32013

Patent Literature 2: JP-A-2010-43670

Patent Literature 3: JP-A-2010-53893

SUMMARY OF INVENTION

### Problems to be Solved by the Invention

However, in the structures of Patent Literatures 1, 2, and 3 described above, there is a concern that, for example, in the case where the gap is exposed to muddy water or similar object the invasion of the muddy water or similar object cannot be prevented completely and the muddy water or similar object invades into the metallic ring so as to reach a slide-contact portion between the seal and the metallic ring. Accordingly, in the structures of Patent Literatures 1, 2, and 3 described above, it is not easy to sufficiently prevent the muddy writer or similar object firm reaching the slide-contact portion between the seal and the metallic ring.

The present invention has been made in view of the above-described circumstances. It is an object of the present invention to provide a novel sealing structure. This sealing structure makes it hard for the muddy water of similar object from outside to reach the slide-contact portion between the lip of the sealing member mounted on the bearing and the metallic ring, and can improve the product lifetime of the bearing.

### Solutions to the Problems

A sealing structure according to the present invention includes: an inside member and an outside member configured to rotate around an axial center relatively to one another; and a sealing member to be mounted on the outside member so as to seal an annular gap between the inside member and the outside member, the inside member having a flange portion with an continuously expanding diameter, a non-rusting metallic ring being fitted to the inside member that includes a base portion the flange portion, the sealing member including at least one lip slidably in contact with the metallic ring. On an outer diameter side of the metallic ring, a folded portion is disposed, the folded portion protruding toward an opposite side of the flange portion in an axial direction, and the outside member includes an extending portion, the extending portion being positioned on an outside in a radial direction with respect to the folded portion of the metallic ring, the extending portion extending toward the flange portion side.

Accordingly, existence of the extending portion on the outside in the radial direction with respect to the folded portion allows reducing muddy water toward the folded portion. The folded portion suppresses invasion of muddy water or similar object, which cannot be blocked by the extending portion, to the side of the lip slidably in contact with the metallic ring. This reduces the situation where the muddy water or similar object reaches the lip slidably in contact with the metallic ring.

In the present invention, in the folded portion, an end edge on the outside in the radial direction may protrude up to a position biased to an opposite side of the flange portion side with respect to an end portion of the extending portion in the axial direction, and the extending portion may have an inclined surface on an inside in the radial direction, the inclined surface having a diameter expanding toward the flange portion side.

In the present invention, the end edge of the folded portion may protrude up to a position overlapping with the inclined surface in the axial direction.

Accordingly, muddy water or similar object from outside becomes less to be directly put on the end edge of the folded portion in particular. This further reduces the situation where the muddy water or similar object reaches the lip slidably in contact with the metallic ring. The muddy water or similar object is blocked by the folded portion even when the muddy water or similar object passes through the gap between the extending portion of the outside member and the flange portion of the inside member. Then, the muddy water or similar object blocked by the folded portion flows down to the inside in the radial direction of the extending portion, thus being simply discharged outside while running on the inclined surface.

In the present invention, the base portion of the flange portion may be formed in an arc shape, the metallic ring may have a curved portion with an arc shape in a cross-sectional view, the arc shape having a curvature radius larger than a curvature radius of the base portion, and the folded portion is formed of an elastomer molded body, the folded portion being fixedly secured to an outer peripheral edge portion of the curved portion.

Accordingly, the folded portion of the metallic ring is constituted of the elastomer molded body. Thus, the folded portion can provide a sealing function even in the case where the folded portion interferes with the outside member.

In the present invention, the base portion of the flange portion may be formed in an arc shape, the metallic ring may have a curved portion with an arc shape in cross-sectional view, the arc shape having a curvature radius larger than a curvature radius of the base portion, and the folded portion may be formed to continuously extend from an outer peripheral edge portion of the curved portion.

Accordingly, the folded portion is made from metal. Thus, even in the case where muddy water or similar object is put on the folded portion, the folded portion is less likely to deteriorate.

In the present invention, the sealing member may be fitted to an inner peripheral portion of the outside member, and the extending portion may be formed such that an end portion on the flange portion side of the outside member protrudes out toward the flange portion side with respect to a fitting portion of the sealing member to the outside member.

Accordingly, the extending portion can be constituted using the outside member.

In the present invention, between the folded portion and the extending portion, a labyrinth may be formed.

This allows suppressing an increase in rotational resistance when the outside member and the inside member concentrically rotate relatively to one another and suppressing invasion of muddy water or similar object.

In the present invention, the sealing member may be fitted to an outer peripheral portion of the outside member so as to be in a state covering an end portion on the flange portion side of the outside member, and the extending portion is integrally formed with the sealing member, and the extending portion being a lip made from elastomer, the lip protruding to be positioned on the outside in the radial direction with respect to the folded portion.

Accordingly, the extending portion is constituted of the lip made from elastomer. This allows increasing the degree of freedom of the shape.

In the present invention, between the folded portion and a portion covering the end portion on the flange portion side of the outside member, a labyrinth may be formed.

This allows suppressing an increase in rotational resistance when the outside member and the inside member concentrically rotate relatively to one another and suppressing invasion of muddy water or similar object.

In the present invention, the lip as the extending portion may form as labyrinth between the extending portion and the flange portion.

Accordingly, the labyrinth is additionally formed on the outside in the radial direction with respect to the folded portion. This allows suppressing invasion of muddy water or similar object from outside to the folded portion side. Additionally, this further reduces the situation where muddy water or similar object reaches the lip slidably in contact with the metallic ring.

Effects of the Invention

The sealing structure of the present invention allows causing muddy water or similar object from outside to become less likely to reach the slide-contact portion between: the lip of the sealing, member mounted on a bearing: and the metallic ring, thus improving the product lifetime of the bearing.

### BRIEF DESCRIPTION OF THE DRAWINGS

FIG. 1 is a vertical cross-sectional view illustrating an exemplary bearing that includes a sealing structure according to one embodiment of the present invention.

FIG. 2 is a vertical cross-sectional view of the sealing structure according to a first embodiment of the present invention, and is an enlarged view of the X portion and the Y portion in FIG. 1.

FIG. 3 is a vertical cross-sectional view according to a modification of the sealing structure.

FIG. 4 is a vertical cross-sectional view of a sealing structure according to a second embodiment of the present invention.

### DESCRIPTION OF EMBODIMENTS

The following describes embodiments of the present invention with reference to the drawings.

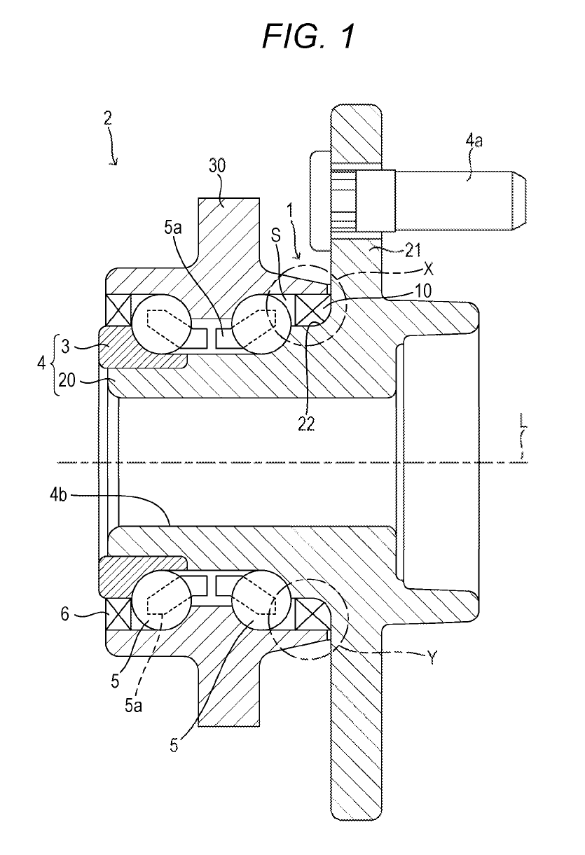

FIG. 1 is a view illustrating an exemplary structure of a hub bearing (bearing) 2 that rotatably supports a wheel of an automobile, This view is to vertical cross-sectional view of the bearing 2 taken along the surface that includes the rotation axis (an axial center 1). Here, in the following description, in a state where the hearing 2 is assembled in a vehicle body. the tire wheel side viewed from the bearing 2 is described as an opposite vehicle body side (an outer side on the right side in the drawing). Additionally, the center portion side of the Vehicle body is described as a vehicle body side (an inner side on the left side in the drawing).

The bearing 2 illustrated in FIG. 1 is the bearing 2 of what is called 3rd generation. The bearing 2 includes an inner ring 4 and an outer ring (outside member) 30. The outside member 30 is externally inserted to this inner ring 4 via a plurality of rolling elements 5.

The outside member 30 is mounted on and secured to a suspension device (not illustrated) of the vehicle body. A wheel hub (inside member) 20, which constitutes the inner ring 4, is constituted of, for example, as material such as carbon steel that is likely to cause rust. To a hub flange (flange portion) 21 of the wheel hub 20, a tire wheel (not illustrated) is secured with a bolt 4a. To a spline shaft hole 4b formed in the inside member 20, as drive shaft (not illustrated) is spline-fitted. Accordingly, the rotary driving force of the drive shaft is drivingly transmitted to the tire wheel. The inside member 20 constitutes the inner ring 4 together with an inner ring member 3.

Between this outside member 30 and the inner ring 4, two rows of the rolling elements 5 . . . are interposed in a state held by a retainer 5a. These rolling elements 5 the inner ring 4, and respective track surfaces formed in the outside member 30 constitute an annular gap S (bearing space). The inner ring 4 is supported to axially rotate around the axial center L with respect to the outside member 30 via this annular gap S. Here, for the bearing 2 on the driven wheel side, the inner ring 4 is not coupled to the drive shall and freely rotates with respect to the outside member 30.

Between the outside member 30 and the inner ring 4 on the inner side of the two rows of the rolling elements 5 . . . , an inner-side seal ring (sealing member) 6 is mounted by press fitting. Between the outside member 30 and the inner ring 4 on the outer side of the two rows of the rolling elements 5 an outer-side seal ring (sealing member) 10 is mounted b press fining. There is provided a structure in which this outer-side sealing member 10 seals the annular gap S between the inside member 20 and the outside member 30. These inner-side and outer-side sealing members and 10 prevents leakage of a lubricant (grease) to be loaded to the rolling portion (the annular gap S) of the rolling elements 5 . . . , or prevents invasion of muddy water or similar object from outside.

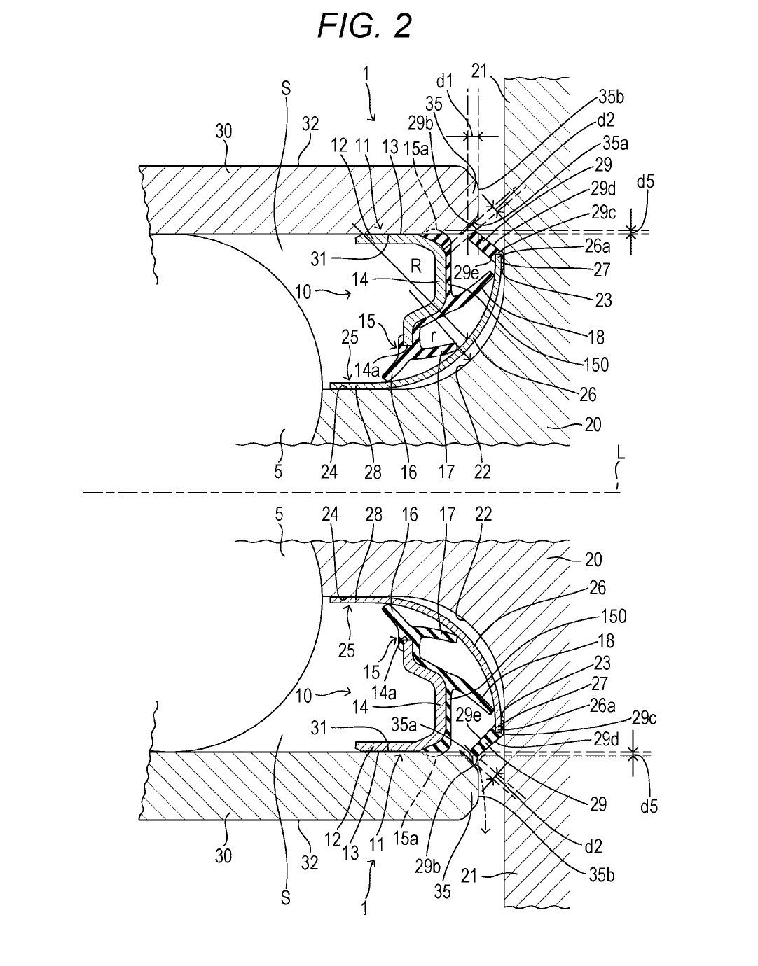

FIG. 2 is an enlarged vertical cross-sectional view of a mounting portion of the outer-side sealing member 10, and illustrates a sealing structure 1 according to a first embodiment of the present invention. The respective views on the top and bottom in FIG. 2 illustrate the X portion and the Y portion in FIG. 1. Here, in the following description, the direction perpendicular to the axial center L is described as a radial direction. The direction separating from the axial center L is described as an outer diameter direction (the upward direction in the view on the top side of FIG. 2).

As illustrated in FIG. 2, the sealing structure 1 according to the embodiment is a structure that includes the inside member 20, the outside member 30, and the sealing member 10. The inside member 20 and the outside member 30 rotate around an axial center relatively to one another. The sealing member 10 is mounted on the outside member 30 to seal the annular gap S between the inside member 20 and the outside member 30.

The inside member 20 has the flange portion 21. The diameter of the flange portion 21 continuously expands in the outer diameter direction toward the outer side.

In the portion in the vicinity of the axial center L of this flange portion 21, the portion that includes side surfaces on the outer diameter side or on the inner side is a base portion 22 of the flange portion 21. This base portion 22 is formed to have a cross section in an approximately arc shape. The base portion 22 has an arc surface with a predetermined curvature radius r.

To the inside member 20 that contains the base portion 22 of the flange portion 21, a metallic ring 25 is fitted. The metallic ring 25 is made of a non-rusting material.

The metallic ring 25 includes a fitting cylindrical portion 28 in a cylindrical shape and a curved portion 26 with an arc-shaped cross section. The fitting cylindrical portion 28 is fitted to an inner-side portion 24 of the base portion 22. The curved portion 26 is disposed in communication with this fitting cylindrical portion 28.

The curved portion 26 has an arc surface with a predetermined curvature radius R. This curvature radius R is set to be larger than the curvature radius r of the base portion 22 of the flange portion 21.

In a state where the metallic ring 25 is fitted to the inside member 20, an outer-diameter-side end portion 27 of the curved portion 26 hits against an outer-diameter-side portion 23 of the base portion 22. Accordingly, the outer-diameter-side portion 23 of the base portion 22 restricts displacement of the curved portion 26 in the axial direction. This consequently reduces variation in interference of lips 17 and 18 (described later) of the sealing member 10 in the axial direction. This allows ensuring a stable sealing performance.

In the metallic ring 25, a folded portion 29 is disposed on the outer diameter side. The folded portion 29 protrudes to the opposite side of the flange portion 21 in the axial direction (the direction along the axial center L).

In this embodiment, the folded portion 29 is fixedly secured to an outer peripheral edge portion 26a of the curved portion 26 of the metallic ring 25. The folded portion 29 is an elastomer molded body formed in a lip shape.

The drawing example illustrates the example where the folded portion 29 is fixedly secured to the outer peripheral edge portion 26a of the curved portion 26 so as to protrude toward the inner side and the outer diameter side. The metallic ring 25 is formed to have an outer diameter smaller than the inner diameter of the outside member 30.

This structure. allows reducing the outer diameter of the metallic ring 25 itself compared with, for example, the metallic ring 25 that includes an umbrella portion on an outer peripheral portion 32 side of the outside member 30 (for example see Patent Literatures 1 to 3). This allows reducing the material cost of the metallic ring 25.

A base portion 29c of the folded portion 29 is fixedly secured to conic around to both the inner side and the outer side of the outer peripheral edge portion 26a. With this structure, the base portion 29c of the folded portion 29 is interposed in a compressed state between the outer peripheral edge portion 26a and the outer-diameter-side portion 23 of the base portion 22. Accordingly, the gap become less likely to occur between these portions. This prevents invasion of muddy water or similar object from between the outer peripheral edge portion 26a of the curved portion 26 and the outer-diameter-side portion 23 of the base portion 2^{.}2. This allows preventing occurrence of rust in the base portion 22 and similar portion.

Here, the metallic ring 25 may be formed also by, for example, performing press working or similar process on a non-rusting austenitic stainless steel sheet (such as SUS304 series in the standard of JIS). Even an easily rusting steel plate can be used for the material of the metallic ring 25 insofar as the easily rusting steel plate undergoes rust-proofing or similar process to be non-rusting. For example, press working or similar process may be performed on a steel plate that has corrosion resistance, for example, a cold rolled steel sheet (such as SPCC series in the standard of JIS) processed by rust-proofing, so as to constitute the non-rusting metallic ring 25.

In this embodiment, the sealing member 10 is fitted to an inner peripheral portion 31 of the outside member 30.

The sealing member 10 includes a cored bar 11 and a seal lip member 15. The cored bar 11 is mounted integrally on the inner peripheral portion 31 of the outside member 30 by press fitting. The seal lip member 15 is integrally and fixedly secured to the cored bar 11, and includes at least one lip slidably in contact with the metallic ring 25. The drawing example illustrates the sealing member 10 that includes the seal lip member 15 with three of lips 16, 17, and 18.

The cored bar 11 includes a fitting cylindrical portion and an inward flange portion 14. The fitting cylindrical portion 12 is press-fitted to the inner peripheral portion 31 of the outside member 30. The inward flange portion 14 is continuously formed from one end portion on the flange portion 21 side of the fitting cylindrical portion 12, and is formed by bending in the axial center L direction. The cored bar 11 is formed approximately in a shape of Katakana Letter “Ko” (an approximately U shape or an approximately C shape) in a cross-sectional view.

In a state where the fitting cylindrical portion 12 is fitted to the inner peripheral portion 31 of the outside member 30, the portion fitted to the inner peripheral portion 31 of the outside member 30 in the fitting cylindrical portion 12 is defined as a fitting portion 13.

For example, the cored bar 11 may be formed by performing press working or similar process on a steel plate with corrosion resistance, for example, an austenitic stainless steel sheet (such as SUS304 series in the standard of JIS) or a cold wiled steel sheet (such as SPCC series in the standard of JIS) processed by rust-proofing.

The seal lip member 15 includes a lip base portion 150 and three of the lips 16, 17, and 18. The lip base portion 150 is integrally and fixedly secured to the outer side surface of the cored bar 11 except the fitting portion 13. The seal lip member 15 illustrated in the drawing is formed of a rubber molded body, and is formed by vulcanizing and integrally molding the cored bar 11 of the rubber material. This lip base portion 150 is fixedly secured and integrated to come around to an axial-center-side edge portion 14a of the inward flange portion 14 toward the inner side.

The lip 16 is a radial lip (grease lip), and decreases in diameter in the axial center L direction toward the inner side from the portion coming around to the axial-center-side edge portion 14a. The lip 16 is formed in a cone shape around the axial center L. The lips 17 and 18 are axial lips. The diameters of the lips 17 and 18 expand in the outer diameter direction toward the outer side from the lip base portion 150. The lips 17 and 18 are formed in concentric cones around the axial center L.

In the portion of the lip base portion 150 in the vicinity of the fitting portion 13, an annular protrusion (nose portion) 15a is formed to protrude to the outer diameter side with respect to the outer peripheral portion of the fitting cylindrical portion 12. By press-fitting the sealing member 10 to the inner peripheral portion 31 of the outside member 30, the annular protrusion 15a is clamped and pressed between the inner peripheral portion 31 of the outside member 30 and the outer peripheral portion of the cored bar 11 in a compressed and elastically deformed state. This mutual contact pressure due to the elastic restoring force maintains a satisfactory sealing pert between the outside member 30 and the sealing member 10. This annular protrusion 15a prevents invasion of muddy water or similar object from between the outside member 30 and the fitting portion 13 of the cored bar 11 into the annular gap S.

In a used state of the bearing 2 assembled as illustrated in FIG. 1, the inside member 20 (the inner ring 4) rotates around the axial center L with respect to the outside member 30. In association with the rotation, the lips 17 and 18 as the axial lips and the lip 16 as radial are brought into elastically sliding in contact with each other on the surface on the sealing member 10 side of the curved portion 26 of the metallic ring 25. Accordingly, this elastic sliding contact portion maintains the sealing performance so as to seal the annular gap S. This blocks invasion of sludge and dust into the annular gap S and blocks outward leakage of grease loaded into the annular gap S.

The outside member 30 includes an extending portion 35, which extends to the flange portion 21 side. At least a part of the extending portion 35 is positioned on the outside in the radial direction with respect to the folded portion 29 of the metallic ring 25.

In this embodiment, the extending portion 35 is formed such that the end portion on the flange portion 21 side of the outside member 30 protrudes out toward the flange portion 21 side with respect to the fining portion 13 of the cored bar 11. Additionally, the extending portion 35 includes an inclined surface 35a on the inside (the axial center L side) in the radial, direction. The diameter of the inclined surface 35a expands toward the flange portion 21 side (the outer side). The inclined surface 35a is formed by performing chamfering or similar process on the inner-diameter-side corner portion of an end portion 35b of the extending portion 35. A gap is formed between the extending portion 35 and the flange portion 21.

A part of this extending portion 35 overlaps with the folded portion 29 in the radial direction (which is illustrated as d1). In the folded portion 29, an end edge 29b on the outside in the radial direction protrudes up to the position biased to the opposite side (the inner side) of the flange portion side with respect to the end portion 35b of the extending portion 35 in the axial direction. The inclined surface 35a of the extending portion 35 overlaps with the end edge 29b of the folded portion 29 in the radial direction.

Accordingly, the folded portion 29 blocks muddy water or similar object from outside even when the muddy water or similar object passes through the gap between the extending portion 35 of the outside member 30 and the flange portion 21 of the inside member 20. The muddy water or similar object blocked by the folded portion 29 flows down on an outer peripheral surface 29d of the folded portion 29 so as to drop onto the inclined surface 35a from the lower portion of the end edge 29b of the folded portion 29. Afterward, the muddy water or similar object is simply discharged outside while running on the inclined surface 35a (see one-dot-chain line arrow in the lower view in FIG. 2). Accordingly, accumulation of the muddy water or similar object from outside at the periphery of the sealing member 10 can be avoided. Even in the case where muddy water or similar object invades the metallic ring 25 side from the gap between the inclined surface 35a of the extending portion 35 and the folded portion 29, the invading muddy water or similar object is simply discharged outside while running on an inner peripheral surface 29e of the folded portion 29 and the inclined surface 35a under its own weight.

Between the folded portion 29 of the metallic ring 25 and the extending portion 35, a labyrinth d2 is formed. The drawing example illustrates the example where the labyrinth d2 is formed between the folded portion 29 and the inclined surface 35a of the extending portion 35. In the radial direction, the end edge 29b on the outer diameter side of the folded portion 29 is positioned on the outer diameter side with respect to the inner peripheral surface of the outside member 30 (see d5). This structure allows forming, the labyrinth d2 with a width in the direction along the inclined surface 35a. This allows further suppressing invasion of muddy water or similar object from outside to the metallic ring 25 side compared with the case where the end edge 29b is disposed on the axial center L side with respect to the inner peripheral surface of the outside member 30. The folded portion 29 is formed of an elastomer molded body. Accordingly, even in the case where the folded portion 29 interferes with the outside member 30, the folded portion 29 makes elastic contact with the outside member 30, thus providing a sealing function.

The labyrinth d2 may be set, for example, in a range of 0.05 to 1.0 mm.

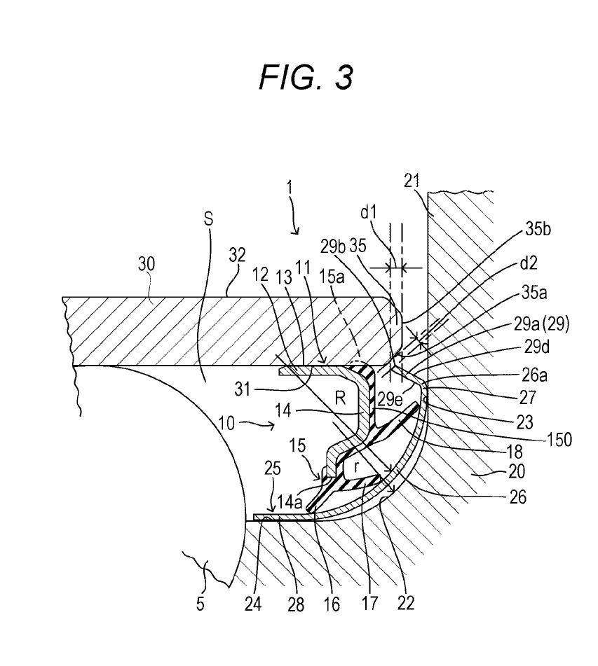

The following describes one modification of the sealing structure 1 according to this embodiment with reference to FIG. 3. Here, the difference from the above-described embodiment will be mainly described. Like configurations will be given the same reference numerals as those in the above and descriptions thereof will be omitted or simplified.

In this modification, a folded portion 29a (29) is formed to continuously extend from the outer peripheral edge portion 26a of the curved portion 26. The folded portion 29a and the curved portion 26 of the metallic ring 25 are continuously formed. This structure allows improving the shape keeping property of the folded portion 29a during rotation of the inner ring 4. The folded portion 29a is made from metal, thus being less likely to deteriorate in the case where muddy water or similar object is put on the folded portion 29a. The metallic ring 25 and the folded portion 29a are constituted as one member, and are manufactured by press working on an annular steel sheet.

The drawing example illustrates the example where the folded portion 29 is formed in the outer peripheral edge portion 26a at the curved portion 26 to protrude toward the opposite side (the inner side) of the flange portion 21 in the axial direction and toward the outer diameter direction.

Similarly to the above-described first embodiment, the labyrinth d2 is formed between the folded portion 29a and the extending portion 35. The drawing example illustrates the example where the labyrinth d2 is formed between the folded portion 29a and the inclined surface 35a of the extending portion 35. The folded portion 29a protrudes such that the end edge 29b on the outside in the radial direction is in the position biased to the opposite side (the inner side) of the flange portion side with respect to the end portion 35b of the extending portion 35 in the axial direction.

Here, the configuration of the extending portion 35 and similar configuration are similar to those in the above-described first embodiment. In this modification, a sealing member or similar member is not disposed between the metallic ring 25 and the flange portion 21. For example, an O-ring as the sealing member may be disposed between the outer peripheral edge portion 26a of the curved portion 26 and the flange portion 21. Alternatively, a rubber material as a sealing material may be integrally molded to come around to the surface on the outer side of the curved portion 26 from the end edge 29b of the folded portion 29a.

The following describes other embodiments according to the present invention with reference to the drawings.

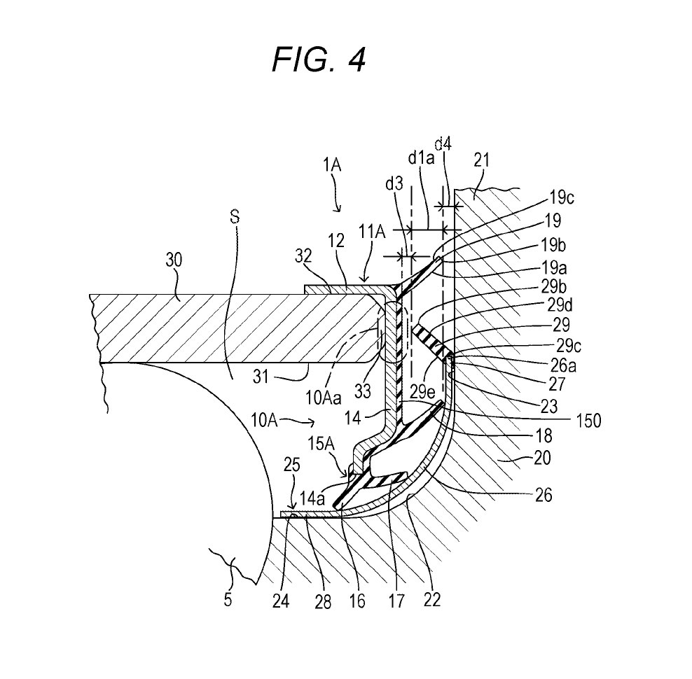

FIG. 4 is a view schematically illustrating an exemplary sealing structure 1A according to a second embodiment.

Here, the difference from the above-described first embodiment will be mainly described. Like configurations will be given the same reference numerals as those in the above and descriptions thereof will be omitted or simplified.

As illustrated in FIG. 4, the sealing structure 1A according to the embodiment has a structure where a sealing member 10A is fitted to the outer peripheral portion 32 or the outside member 30.

The fitting cylindrical portion 12 of a cored bar 11A fits the outer peripheral portion 32 of the outside member 30, so as to achieve a structure where the sealing member 10A is fitted to the outer peripheral portion 32 of the outside member 30. The drawing example illustrates the example where the inward flange portion 14 of the cored bar 11A is in contact with the end portion 33 on the flange portion 21 side of the outside member 30.

The inward flange portion 14 of the cored bar 11A according to this embodiment has a larger size in the radial direction compared with the inward flange portion 14 of the cored bar 11 in the first embodiment.

Accordingly, fitting the sealing member 10A to the outer peripheral portion 32 of the outside member 30 causes the sealing member 10A to be in the state covering the end portion 33 on the flange portion 21 side of the outside member 30.

In the above-described first embodiment, the extending portion 35 is disposed in the outside member 30. In this embodiment, an extending portion 19 is integrally formed with the sealing member 10A, and is constituted of the lip made from elastomer. The lip protrudes to be in the position on the outside in the radial direction with respect to the folded portion 29.

In this embodiment, a part of the extending portion 19 overlaps with the folded portion 29 of the metallic ring 25 in the radial direction (which is illustrated as d1a). In the folded portion 29, the end edge 29b on the outside in the radial direction protrudes up to the position on the opposite side of the flange portion side (the inner side) with respect to all end portion 19b the extending portion 19 in the axial direction.

The drawing example illustrates the example where the extending port on disposed to protrude from the upper end portion of the lip base portion 150 of a seal lip member 15A toward the outer diameter side and toward the flange portion 21 side (the outer side). The extending portion 19 is disposed to protrude toward the outer diameter side and toward the outer side from the portion in the vicinity of the coupling portion between the fitting cylindrical portion 12 and the inward flange portion 14 in the lip base portion 150. The extending portion 19 is formed in concentric cone shape around the axial center L to have a diameter that expands in the outer diameter direction from the lip base portion 150 toward the outer side.

A labyrinth d3 is formed between the folded portion 29 and a portion (a covering portion 10Aa) that covers the end portion 33 on the flange portion 21 side of the outside member 30. The covering portion 10Aa is a portion that covers the end portion 33 on the flange portion 21 side of the outside member 30 in the sealing. member 10A. The covering portion 10Aa is constituted of a part of the cored bar 11A and a part of the lip base portion 150 of the seal lip member 15A.

This labyrinth d3 is formed between the folded portion 29 and the lip base portion 150 of the seal lip member 15A in the covering portion 10Aa. Furthermore, a labyrinth d4 is formed between the extending portion 19 and the flange portion 21. The labyrinth d3 is the position different from the position of the labyrinth d4 in the axial direction and in the radial direction.

The labyrinths d3 and d4 may be set, for example, in a range of 0.05 to 1 .0 mm similarly to the labyrinth d2 in the first embodiment.

With this configuration muddy water or similar object from outside is discharged outside while running on an outer peripheral surface 19c of the extending portion 19 when the muddy water or similar object is put on the extending portion 19. The extending portion 19, which is positioned on the most outer diameter side, and the folded portion 29, which is positional on the axial center L side with respect to the extending portion 19, doubly suppress invasion of muddy water or similar object from outside to the annular gap S side. That is, the labyrinth d3 is located in the position not overlapping with the labyrinth d4 in the axial direction and in the radial direction, Accordingly, muddy water or similar object is less likely to reach the labyrinth d even when the labyrinth d4 is exposed to the muddy water or similar object. Furthermore, in the case where muddy water or similar object passes through the labyrinth d4, the invasion is blocked by the folded portion 29. There is achieved a. structure where the blocked muddy water or similar object runs on the miler peripheral surface 29d of the folded portion 29 and an inclined surface 19a of the extending portion 19 so as to be discharged from the labyrinth d4. This allows avoiding accumulation of the muddy water or similar object at the periphery of the sealing member 10. Here, in this embodiment, the folded portion 29 is constituted of the lip formed of an elastomer molded body. This, however, should not be construed in a limiting sense. Like the modification of the first embodiment, the folded portion 29 may be formed to continuously extend from the outer peripheral edge portion 26a of the curved portion 26. The folded portion 29 and the metallic ring 25 may be constituted of one member.

Here, in the respective above-described embodiments, there are described the examples where the seal lip members 15 and 15A are rubber vulcanized molded bodies. The seal lip members 15 and 15A may be synthetic resin molded bodies with elasticity.

The shapes of the seal lip members 15 and 15A (including the number of lips), the shapes of the cored bars 11 and 11A, the shape of the lip as the extending portion 19, the shapes of the folded portions 29 and 29a, and similar shape are not limited to those described as examples.

In the respective above-described embodiments, the bearing 2 of what is called 3rd generation is described as an example. This, however, should not be construed in a limiting sense. The bearing 2 may be 2nd generation or 4th generation. Also, the description has been given of the example where the bearing 2 to which the sealing member 10 and 10A are applied is a hub bearing. This, however, should not be construed in a limiting sense. The sealing member 10 and 10A may be applied to another bearing constituted similarly.

In the respective above-described embodiments, there are described the examples where the metallic ring 25 is formed in an arc shape. This, however, should not be construed in a limiting sense. For example, the metallic ring 25 may have an approximately L shape in a cross-sectional view and may have a structure fitted to the inside member 20.

In the respective above-described embodiments, there are described the examples where the extending portion 35 (19) have the inclined surface 35a (19a) on the inside in the radial direction and where the diameter of the inclined surface 35a (19a) expands toward the flange portion 21. This, however, should not be construed in a limiting sense. In one aspect, this inclined surface 35a (19a) need not be disposed. Also in this case, for example, a lip formed of a molded body of rubber or similar material may be fixedly secured to the outer peripheral edge portion of the circular plate portion of the metallic ring 25. A labyrinth may be formed by the lip and the inner peripheral portion 31 of the outside member 30.

In the respective above-described embodiments (except the modification of the first embodiment), there are described the examples where the labyrinth d2 (d3) is formed between the extending portion 35 (19) and the folded portion 29. This aspect is not required. Thus, in the case where the folded portion 29 is formed of an elastomer molded body, in one aspect, the labyrinth d2 (d3) need not be formed by bringing, the distal end portion of the folded portion 29 into contact with the extending portion 35 (19). This allows eliminating the gap between the folded portion 29 and the extending portion 35 (19). This allows suppressing invasion of muddy water or similar object from outside up to the slide-contact portion between the lip 18 and the metallic ring 25. In one aspect, the labyrinth d2 (d3) need not be formed by shortening the extension length of the folded portion 29 and so as to enlarge the gap between the end edge 29b of the folded portion 29 and the extending portion 35 (19).

In the respective above-described embodiments, as one example, the extending portion 35 (19) is formed by causing the end portion on the flange portion 21 side of the outside member 30 to protrude out toward the flange portion 21 side. Alternatively, as one example, the extending portion 19 is constituted as the lip integrally formed with the sealing member 10A. However, the extending portion 35 (19) is not limited to these aspects. For example, the extending portion 35 (19) may be constituted by mounting another member different from these outside member 30 and sealing member 10A on the outside member 30.

In the above-described first embodiment, a labyrinth may be formed between the extending portion 35 and the flange portion 21 by additionally extending the extending portion 35, which is constituted of a part of the outside member 30, to the flange portion 21 side. The metallic ring 25 in the respective above-described embodiment may be subjected to various treatments. For example, a roughening treatment for reducing the sliding friction with the surface of the metallic ring 25 slidably in contact with the lips 16, 17, and 18 and similar member. Here, a possible roughening treatment performed in this case is, for example, setting an arithmetic average roughness Ra of the sliding contact surface of the metallic ring 25 in a range of 0.3 μm to 2.0 μm using shot blasting or similar treatment.

### DESCRIPTION OF REFERENCE SIGNS

1, 1A Sealing structure

10, 10A Sealing member

10Aa Covering portion (portion covering end portion on flange portion side)

13 Fitting portion

16, 17, 18 Lip

20 Inside member

21 Flange portion

22 Base portion

25 Metallic ring

26 Curved portion

26a Outer peripheral edge portion

29, 29a Folded portion

30 Outside member

31 Inner peripheral portion

32 Outer peripheral portion

33 End portion

19, 35 Extending portion

19a, 35a Inclined surface d2, d3, d4 Labyrinth

S Annular gap

1. A sealing structure, comprising: an inside member and an outside member configured to rotate around an axial center relatively to one another; and a sealing member to be mounted on the outside member so as to seal an annular gap between the inside member and the outside member, the inside member having a flange portion with an continuously expanding diameter, a non-rusting metallic ring being fitted to the inside member that includes a base portion of the flange portion, the sealing member including at least one lip slidably in contact with the metallic ring, wherein
on an outer diameter side of the metallic ring, a folded portion is disposed, the folded portion protruding toward an opposite side of the flange portion in an axial direction, and
the outside member includes an extending portion, the extending portion being positioned on an outside in a radial direction with respect to the folded portion of the metallic ring, the extending portion extending toward the flange portion

2. The sealing structure according to claim 1, wherein
in the folded portion, an end edge on the outside in the radial direction protrudes up to a position biased to an opposite side of the flange portion side with respect to an end portion of the extending portion in the axial direction, and
the extending portion has an inclined surface on an inside in the radial direction, the inclined surface having a diameter expanding toward the flange portion side.

3. The sealing structure according to claim 2, wherein
the end edge of the folded portion protrudes up to a position overlapping with the inclined surface in the axial direction.

4. The sealing structure according to claim 1, wherein
the base portion of the flange portion is formed in an arc shape,
the metallic ring has a curved portion with an arc shape in a cross-sectional view, the arc shape having a curvature radius larger than a curvature radius of the base portion, and
the folded portion is formed of an elastomer molded body, the folded portion being fixedly secured to an outer peripheral edge portion of the curved portion.

5. The sealing structure according to claim 1, wherein
the base portion of the flange portion is formed in an arc shape,
the metallic ring has a curved portion with an arc shape in a cross-sectional view, the arc shape having a curvature radius larger than a curvature radius of the base portion, and
the folded portion is formed to continuously extend from an outer peripheral edge portion of the curved portion.

6. The sealing structure according to claim 1, wherein
the sealing member is fitted to an inner peripheral portion of the outside member, and
the extending portion is formed such that an end portion on the flange portion side of the outside member protrudes out toward the flange portion side with respect to a fitting portion of the sealing member to the outside member.

7. The sealing structure according to claim 6, wherein
between the folded portion and the extending portion, a labyrinth is formed.

8. The sealing structure according to claim 1, wherein
the sealing member is fitted to an outer peripheral portion of the outside member so as to be in a state covering an end portion on the flange portion side of the outside member, and
the extending portion is integrally formed with the sealing member, and the extending portion being a lip made from elastomer, the lip protruding to be positioned on the outside in the radial direction with respect to the folded portion.

9. The sealing structure according to claim 8, wherein
between the folded portion and a portion covering the end portion on the flange portion side of the outside member, a labyrinth is formed.

10. The sealing structure according to claim 8, wherein
the lip as the extending portion forms a labyrinth between the extending portion and the flange portion.

11. The sealing structure according to claim 9, wherein
the lip as the extending portion forms a labyrinth between the extending portion and the flange portion.
